(19) United States
(12) Patent Application Publication
(10) Pub. No.: US 2018/0025247 A1
(43) Pub. Date: Jan. 25, 2018

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventor: Akihiro Kohno, Kawasaki-shi (JP)

(21) Appl. No.: 15/651,223

(22) Filed: Jul. 17, 2017

(30) Foreign Application Priority Data
Jul. 19, 2016 (JP) 2016-141290

(51) Int. Cl. G06K 9/20; G06F 3/0481; G06K 9/00

(52) U.S. Cl. CPC G06K 9/209; G06K 9/00771; G06F 3/0481

(57) ABSTRACT

Upon input of conditions of a scale, the height of a ceiling, and an algorithm in an operation area through an operation by a user and dragging of a detection position object with a pointer by the user to set a detection position in a layout guide, an information processing apparatus displays a mounting position guide indicating a position where a camera is capable of being arranged on the layout guide in accordance with the algorithm that is selected.

### BACKGROUND

### Field of the Disclosure

The aspect of the embodiments relates to an information processing apparatus, an information processing method, and a program which are capable of being desirably used to support mounting of a camera.

### Description of the Related Art

Methods have heretofore been known which detect human bodies from images. It is desirable to reduce obstacles that shield human bodies and to detect the human bodies from angles at which the human bodies are easily detected in the detection of the human bodies. Accordingly, the positions where cameras are mounted are important factors for the detection of the human bodies. Japanese Patent No. 5325251 discloses a mounting support method of appropriately detecting a monitoring target according to a guidance using an captured image in mounting of a camera.

A wide variety of object detection functions have been used in recent years. For example, various detection functions including a function to recognize an object from directly above and a function to detect an object from a side are adopted. However, the efficiency of detection is reduced if a camera is mounted so as to capture an image of an object from a side in an algorithm in which the object is desirably detected from directly above or a camera is mounted so as to capture an image of an object from directly above in an algorithm in which the object is desirably detected from a side. In addition, monitoring systems using network cameras are increased in size and efficient mounting of appropriate cameras is requested.

### SUMMARY

The aspect of the embodiments provides an information processing apparatus including a display control unit that displays in a display unit a range in which a camera is capable of being arranged with respect to a position or a range where the camera captures an image based on an imaging condition input with an input unit. The imaging condition at least includes information about the position or the range where the camera captures an image and about an angle in a vertical direction at which the camera captures an image. The input unit is used to input the imaging condition.

Further features of the present disclosure will become apparent from the following description of exemplary embodiments with reference to the attached drawings.

### BRIEF DESCRIPTION OF THE DRAWINGS

FIG. 1 is a block diagram illustrating an exemplary hardware configuration of a camera mounting support apparatus according to one or more aspects of the present disclosure.

FIG. 2 is a block diagram illustrating an exemplary functional configuration of the camera mounting support apparatus according to one or more aspects of the present disclosure.

FIG. 3 illustrates an exemplary display screen with which mounting of a camera is supported in a first embodiment according to one or more aspects of the present disclosure.

FIG. 4 illustrates an exemplary display screen with which mounting of a camera is supported in a second embodiment according to one or more aspects of the present disclosure.

FIG. 5 illustrates an exemplary display screen with which mounting of a camera is supported in a fourth embodiment according to one or more aspects of the present disclosure.

FIG. 6 is a flowchart illustrating an exemplary process to display mounting position guides of a camera in the first embodiment according to one or more aspects of the present disclosure.

FIG. 7 is a flowchart illustrating an exemplary process to display the mounting position guides of a camera in the second embodiment according to one or more aspects of the present disclosure.

FIG. 8 is a diagram for describing the position of a camera in Human body detection 1 according to one or more aspects of the present disclosure.

FIGS. 9A and 9B are diagrams for describing a mounting condition of a camera according to one or more aspects of the present disclosure.

FIGS. 10A and 10B illustrate exemplary display screens including the mounting position guides for the cameras of different kinds according to one or more aspects of the present disclosure.

### DESCRIPTION OF THE EMBODIMENTS

### First Embodiment

A first embodiment of the disclosure will herein be described with reference to the drawings.

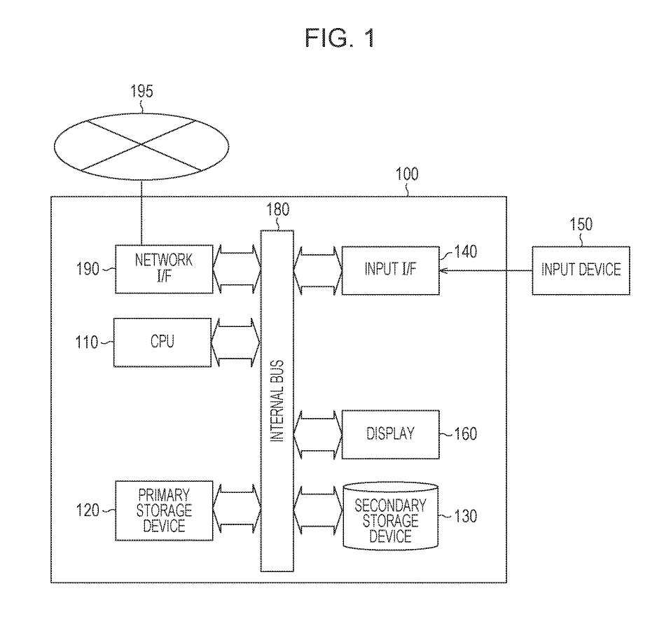

FIG. 1 is a block diagram illustrating an exemplary hardware configuration of a camera mounting support apparatus 100, which is an information processing apparatus.

Referring to FIG. 1, the camera mounting support apparatus 100 includes a central processing unit (CPU) 110, a primary storage device 120, a secondary storage device 130, an input interface (I/F) 140, a display 160, and a network I/F 190. These components are connected to each other via an internal bus 180.

The CPU 110 performs a variety of processing and various arithmetic operations.

The primary storage device 120 is a writable high-speed storage device, such as a random access memory (RAM). An operating system (OS), various programs, and a variety of data are loaded in the primary storage device 120. The primary storage device 120 is also used as a working area for the OS and the various programs.

The secondary storage device 130 is a non-volatile storage device, such as a hard disk drive (HDD), a flash memory, or a compact disc read only memory (CD-ROM). The secondary storage device 130 is used as a permanent storage area for the OS, the various programs, and the variety of data. The secondary storage device 130 is also used as a short-term storage area for the variety of data.

The input I/F 140 is an interface used to connect to an input device 150, such a keyboard and/or a mouse. An instruction is input into the camera mounting support apparatus 100 with the input device 150.

The display 160 is an output device that displays an image or the like.

The network I/F 190 is an interface used to connect to a network 195 for a variety of communication.

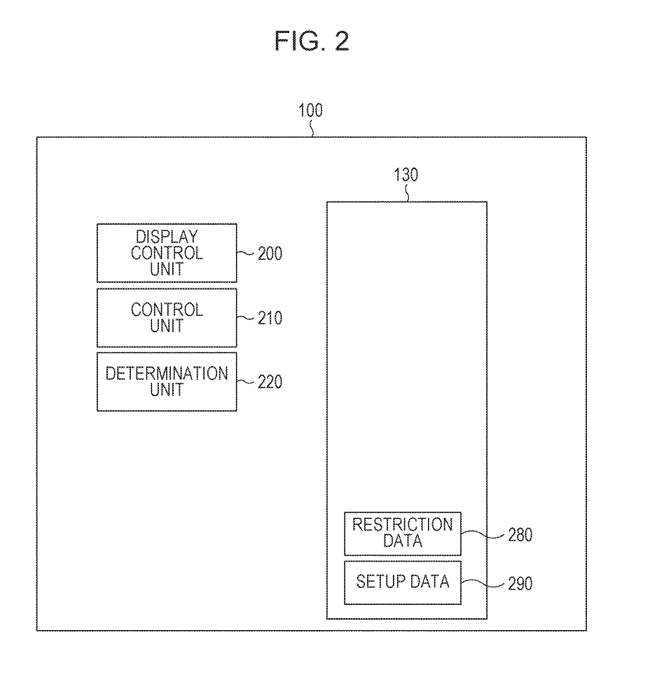

FIG. 2 is a block diagram illustrating an exemplary functional configuration of the camera mounting support apparatus 100 according to the first embodiment.

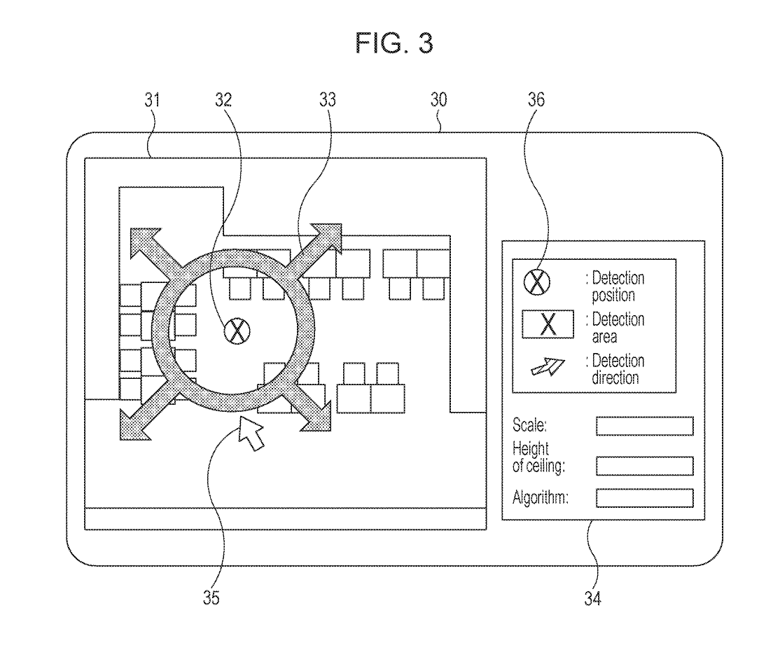

Referring to FIG. 2, the camera mounting support apparatus 100 includes a display control unit 200, a control unit 210, and a determination unit 220. For example, restriction data 280 and setup data 290 are stored in the secondary storage device 130 in the camera mounting support apparatus 100. The setup data 290 is necessary to display a display screen, such as a display screen illustrated in FIG. 3, with which mounting of a camera is supported. The restriction data 280 will be described in detail below.

The display control unit 200 displays a variety of information on the display 160 in accordance with the setup data 290 stored in the secondary storage device 130. In the first embodiment, the display control unit 200 displays the display screen with which mounting of a camera is supported on the display 160.

FIG. 3 illustrates an example of the display screen with which mounting of a camera is supported in the first embodiment.

As illustrated in the example in FIG. 3, a display screen 30 to guide a mounting position of a camera at a certain location is displayed on the display 160, for example, in order to detect a human body at the certain location. More specifically, the display control unit 200 first displays a layout guide 31, such as a map, which indicates the site where the camera is mounted on the display screen 30. At this time, the display control unit 200 also displays an operation area 34 used to input, for example, scale information and information about the height of the ceiling so as to indicate actual dimensions in the map on the display screen 30. For example, “Scale” is indicated using a unit of pixels/m, which indicates how many pixels on the display screen 30 correspond to one meter. “Height of ceiling” is indicated as a height h in units of meters. “Algorithm” is selected from a pull-down menu. The “Scale”, the “Height of ceiling”, and the “Algorithm” are described in detail below.

In addition, the display control unit 200 displays a detection position 32 indicating the position of the human body, which will be detected in accordance with control by the control unit 210 described below, on the layout guide 31. For example, a user is capable of determining the detection position 32 by dragging a detection position object 36 in the operation area 34 with a pointer 35 using the input device 150.

Furthermore, the display control unit 200 displays mounting position guides 33 on the layout guide 31 in order to indicate a mounting condition of the camera to be mounted. The mounting position guides 33 are indicated as, for example, an area apart from the detection position 32 by a predetermined distance. In the first embodiment, the mounting position guides 33 are indicated as a circle having a certain radius around the detection position 32 and the camera is guided to be desirably mounted in the area outside the circle. The mounting position guides 33 are displayed in response to a notification of display from the determination unit 220 described below. As described above, the display control unit 200 displays guide information used to mount the camera in response to instructions from the control unit 210 and the determination unit 220.

The control unit 210 controls the camera mounting support apparatus 100 in accordance with an operation by the user with the input device 150 or an event based on the display screen 30. Upon input of values or the likes in the “Scale”, the “Height of ceiling”, and the “Algorithm” in the operation area 34 with the input device 150 and instruction of the detection position 32 with the input device 150, the control unit 210 indicates input information (an imaging condition) to the display control unit 200 and the determination unit 220. The determination unit 220 performs calculation based on the input information and instructs the display control unit 200 to display the mounting position guides 33. Since the indication of the input information (the image capturing condition) and the instruction to display the mounting position guides 33 are processes corresponding to general operations or events, a detailed description of them is omitted herein.

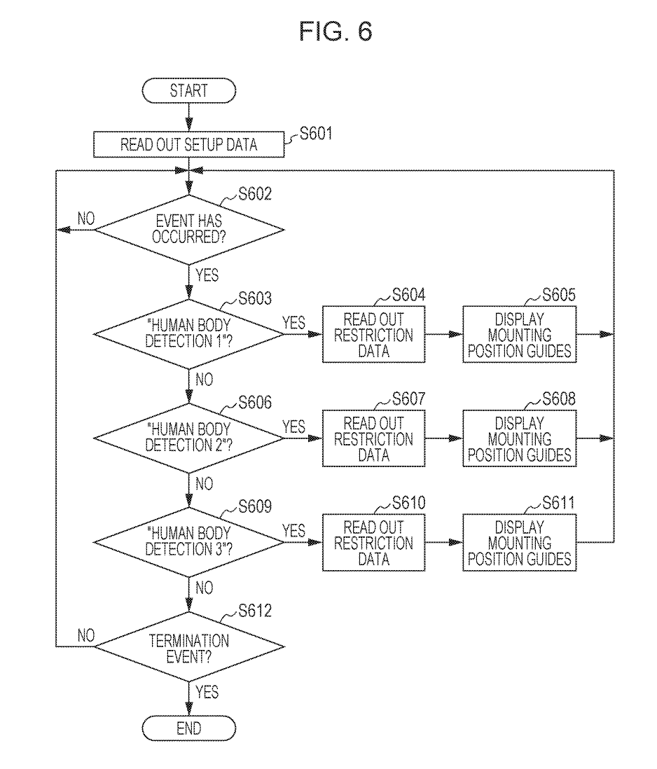

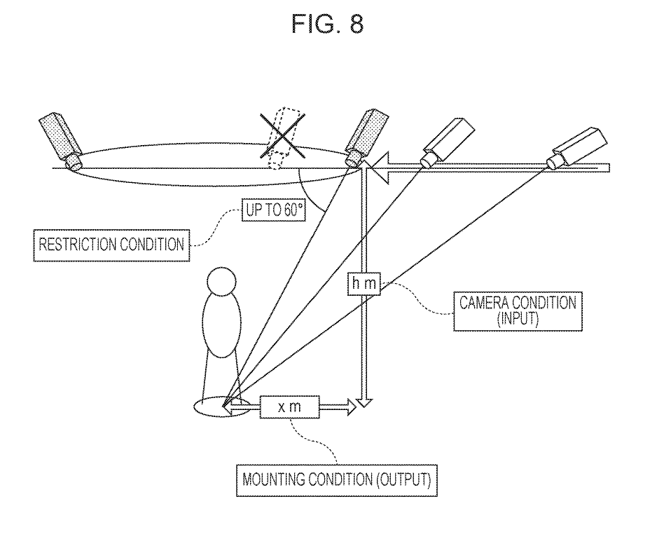

FIG. 6 is a flowchart illustrating an exemplary process to display the mounting position guides 33 of a camera in the first embodiment. An example is described in the first embodiment in which information used to mount cameras of three kinds is displayed. The “Algorithm” described above is an algorithm to make a setting for each camera and the functions of the cameras of three kinds are “Human body detection 1”, “Human body detection 2”, and “Human body detection 3”. The “Human body detection 1” supposes detection of a human body from a direction of a depression angle of 60 degrees or less from the ceiling, as illustrated in FIG. 8. The “Human body detection 2” supposes detection of a human body from directly above (a depression angle of 90 degrees). The “Human body detection 3” supposes detection of a human body from a side (a depression angle of zero degrees). As described above, the functions of the cameras are classified in accordance with the angle in the vertical direction at which each camera captures an image in the first embodiment.

Referring to FIG. 6, in Step S601, the display control unit 200 reads out the setup data 290 from the secondary storage device 130 and displays the display screen 30 to guide the position where the camera is to be mounted on the display 160. In Step S602, the control unit 210 waits for an operation by the user with the input device 150 to cause an event based on the display screen 30. In other words, the control unit 210 waits for input of values or the likes in the operation area 34 and setting of the detection position 32.

If an event has occurred in Step S602 (YES in Step S602), in Step S603, the control unit 210 determines whether the “Human body detection 1” is selected in the “Algorithm” in the operation area 34. If the control unit 210 determines that the “Human body detection 1” is not selected (NO in Step S603), the process goes to Step S606. If the control unit 210 determines that the “Human body detection 1” is selected (YES in Step S603), in Step S604, the determination unit 220 reads out the restriction data 280 from the secondary storage device 130. Here, the restriction data 280 is, for example, data in which a function or the like to calculate an output x for an input is registered.

The restriction data 280 to be read out in Step S604 will now be described. Since a human body is detected at a depression angle of 60 degrees or less from the ceiling in the “Human body detection 1”, the restriction data 280 is used to calculate a distance x illustrated in FIG. 8 for an input of a height of ceiling h. Since the distance x≧h×tan(90°−60°) in the “Human body detection 1”, a result of “the distance x is h×tan 30° or more” is attained as an output.

In Step S605, the determination unit 220 calculates the distance x by substituting the height of ceiling h based on the input information supplied from the control unit 210 in the restriction data 280. Then, the display control unit 200 displays the mounting position guides 33 on the layout guide 31 based on the distance x, which is an output. Then, the process goes back to Step S602.

In Step S606, the control unit 210 determines whether the “Human body detection 2” is selected in the “Algorithm” in the operation area 34. If the control unit 210 determines that the “Human body detection 2” is not selected (NO in Step S606), the process goes to Step S609. If the control unit 210 determines that the “Human body detection 2” is selected (YES in Step S606), in Step S607, the determination unit 220 reads out the restriction data 280 from the secondary storage device 130.

The restriction data 280 to be read out in Step S607 will now be described. Since the “Human body detection 2” is an algorithm in which a human body is detected from directly above, the distance x, which is an output, is calculated as “x=0” from the restriction data 280. In Step S608, the display control unit 200 displays a small circle concentric with the detection position 32 on the layout guide 31 as the mounting position guides 33. Then, the process goes back to Step S602.

In Step S609, the control unit 210 determines whether the “Human body detection 3” is selected in the “Algorithm” in the operation area 34. If the control unit 210 determines that the “Human body detection 3” is not selected (NO in Step S609), the process goes to Step S612. If the control unit 210 determines that the “Human body detection 3” is selected (YES in Step S609), in Step S610, the determination unit 220 reads out the restriction data 280 from the secondary storage device 130.

The restriction data 280 to be read out in Step S610 will now be described. Since the “Human body detection 3” is an algorithm in which a human body is detected from a side, the height x, which is an output, is calculated as “the height x=if (j<1.50) then j else 150” from the restriction data 280. Specifically, the height x is set to the height of ceiling that is input in the case of a ceiling (for example, a loft or an attic) lower than the height 1.50 m of the human body and the height x is otherwise set to a fixed value of 1.50 meter. In Step S611, the display control unit 200 displays the mounting position guides 33, such as “mounting height of x meter”, on the layout guide 31 using a text or the like. Then, the process goes back to Step S602.

In Step S612, the control unit 210 determines whether termination of the event is instructed through an operation by the user with the input device 150. If the control unit 210 determines that termination of the event is not instructed (NO in Step S612), the process goes back to Step S602. If the control unit 210 determines that termination of the event is instructed (YES in Step S612), the process illustrated in FIG. 6 is terminated.

As described above, according to the first embodiment, the camera mounting support apparatus 100 is capable of displaying the mounting condition corresponding to the restriction of each algorithm in response to an input of the detection position 32 or an input in the operation area 34. The mounting position guides 33 may be a schematic view or a text. It is sufficient for the mounting position guides 33 to explicitly indicate the mounting position.

### Second Embodiment

Although the mounting position guides corresponding to the detection position are displayed in the first embodiment, an example will be described in a second embodiment in which the mounting position guides are indicated with a detection area being specified, instead of the detection position. Since the internal configuration of the camera mounting support apparatus 100 according to the second embodiment is the same as the ones illustrated in FIG. 1 and FIG. 2, a description of the internal configuration of the camera mounting support apparatus 100 according to the second embodiment is omitted herein. Only points different from the first embodiment will be described here.

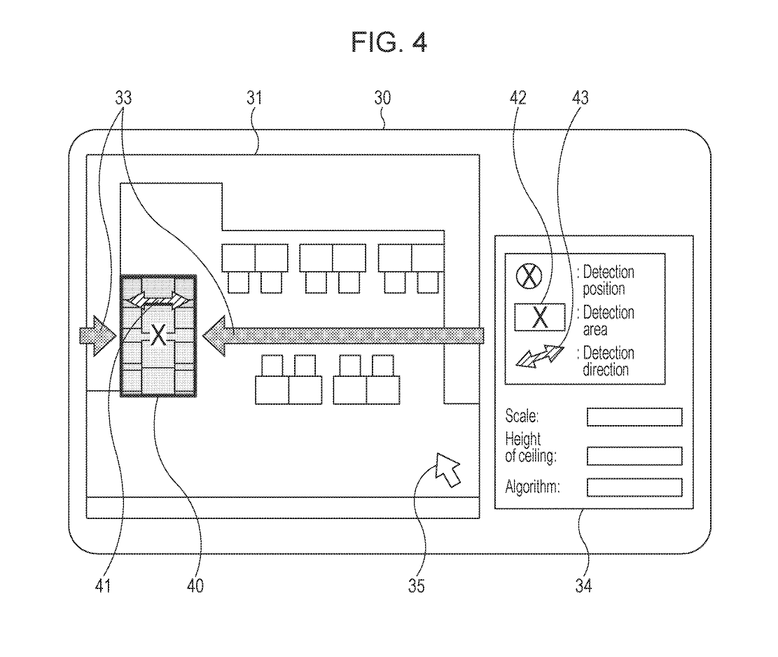

FIG. 4 illustrates an example of the display screen with which mounting of a camera is supported in the second embodiment.

For example, when an area where a single operation is to be detected is monitored, it is necessary to capture an image of a human body from a front-back direction of the human body. In this case, the camera is mounted with the restriction of the “Human body detection 1” being added. More specifically, the display control unit 200 displays a detection area 40 and a detection direction 41 on the display screen 30 on which the layout guide 31 has been displayed, as illustrated in FIG. 4. In the display of the detection area 40 and the detection direction 41, for example, a detection area object 42 in the operation area 34 is instructed with the pointer 35 to arrange a rectangle at a desired position on the layout guide 31 and a detection direction object 43 in the operation area 34 is instructed with the pointer 35 to set a desired direction.

In response to the above operations by the user, the mounting position guides 33 are displayed based on the detection area 40 and the detection direction 41. The mounting position guides 33 are indicated as areas that pass through the center of the detection area 40, that are on a line segment parallel to the detection direction 41, and that are apart from the center of the detection area 40 by a predetermined distance. In the second embodiment, line segments from positions that are apart from the center of the detection area 40 along the detection direction 41 by a certain distance or more are displayed as the mounting position guides 33. Accordingly, the two mounting position guides 33 on the left and right sides of the detection area are displayed in accordance with the restriction to capture an image of the human body from the front-back direction of the human body.

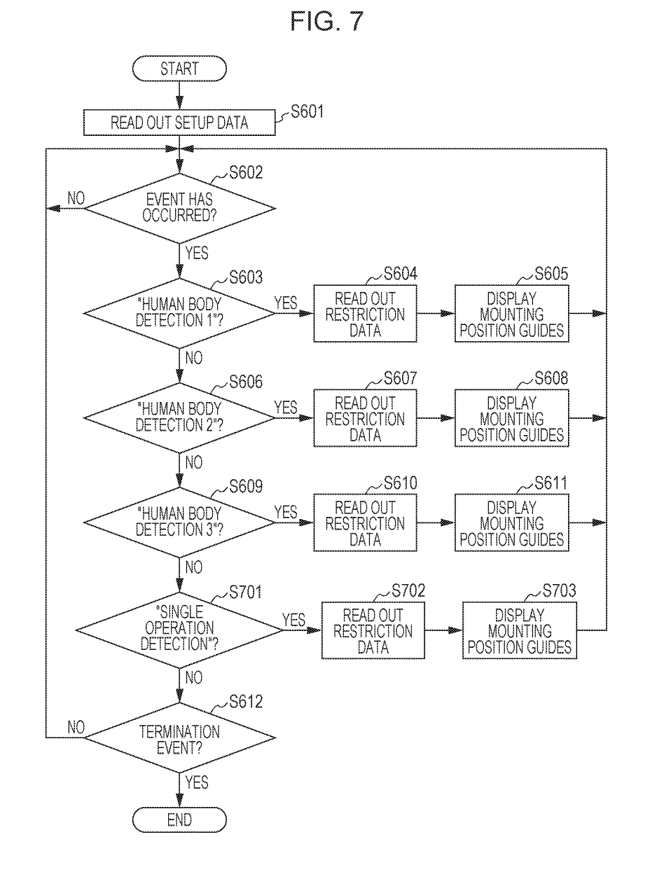

FIG. 7 is a flowchart illustrating an exemplary process to display the mounting position guides 33 of a camera in the second embodiment. Only points different from FIG. 6 will be described here. In the second embodiment, the “Algorithm” includes the functions of cameras of four kinds: “Human body detection 1”, “Human body detection 2”, “Human body detection 3”, and “Single operation detection”.

Referring to FIG. 7, in Step S701, the control unit 210 determines whether the “Single operation detection” is selected in the “Algorithm” in the operation area 34. In other words, the control unit 210 determines whether the detection area 40 and the detection direction 41 are set by the user according to the process described above on the display screen 30 illustrated in FIG. 4. If the control unit 210 determines that the “Single operation detection” is selected (YES in Step S701), the process goes to Step S702. If the control unit 210 determines that the “Single operation detection” is not selected (NO in Step S701), the process goes to Step S612.

In Step S702, the determination unit 220 reads out the restriction data 280 from the secondary storage device 130. The restriction data 280 to be read out in Step S702 will now be described. In the “Single operation detection”, a human body is detected at a depression angle of 60 degrees or less from the ceiling and the single operation is detected. Accordingly, the distance x, which is an output, is greater than or equal to h× tan 30° or more (x≧h× tan 30° or more) and is on a line segment that passes through the center of the rectangular detection area 40 and that is parallel to the detection direction 41. In Step S703, the display control unit 200 displays arrows illustrated in FIG. 4 on the layout guide 31 as the mounting position guides 33. Then, the process goes back to Step S602.

As described above, according to the second embodiment, the camera mounting support apparatus 100 is capable of displaying the mounting condition corresponding to the restriction of each algorithm as the mounting position guides 33 by specifying the detection area 40 and the detection direction 41.

### Third Embodiment

Although the mounting position guides corresponding to the detection area and the detection direction are displayed in the second embodiment, an example will be described in a third embodiment in which a camera to be mounted is specified and the mounting position of the camera is displayed. Since the internal configuration of the camera mounting support apparatus 100 according to the third embodiment is the same as the ones illustrated in FIG. 1 and FIG. 2, a description of the internal configuration of the camera mounting support apparatus 100 according to the third embodiment is omitted herein. Only points different from the second embodiment will be described here.

The kind of the camera to be mounted is capable of being input in the operation area 34 illustrated in FIG. 4 in the third embodiment. The kind of the camera is specified as a camera model name, such as “Camera A” or “Camera B”.

Although the process according to the third embodiment is basically the same as the one illustrated in FIG. 7, the process according to the third embodiment differs from the one illustrated in FIG. 7 in the following points. In the third embodiment, the following restrictions are further considered in the restriction data 280 to be read out in Step S702 in accordance with a database of the conditions of the cameras of the respective kinds. In particular, optical information and information about an imaging sensor are held as the conditions of the cameras of the respective kinds. The conditions of the cameras of the respective kinds include the angle of view of the wide angle end, the angle of view of the telephoto end, the resolution, the aspect ratio of each camera.

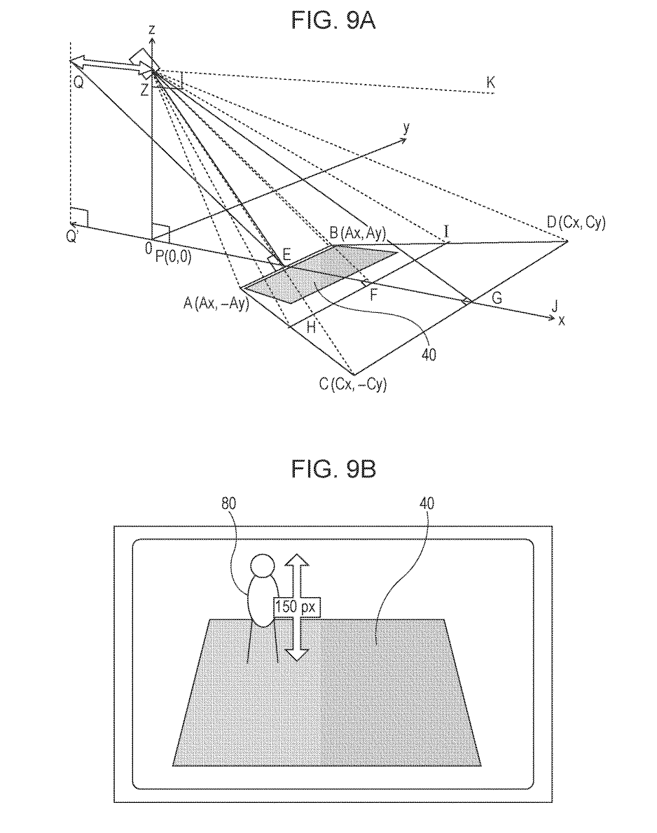

As illustrated in FIG. 9B, inclusion of an object (a human body 80) within an imaging range at least at the wide angle end of the corresponding camera is taken into consideration. If the human body 80 is not included within the imaging range, the minimum distance of the distance x is increased to a distance where the human body 80 is within the imaging range at the wide angle end. A specific example is illustrated in FIG. 9A.

Referring to FIG. 9A, it is necessary to include a width AB of the detection area 40 within the imaging range in order to include the detection area 40 within the imaging range of the camera as a first condition. For this end, a wide angle end meeting a horizontal angle of view HZI and a vertical angle of view EZG is set. Accordingly, the camera A is arranged so that a trapezoid ABDC in FIG. 9A is an effective field of view. Here, it is necessary to set a depression angle KZF (=∠PFZ) to 60 degrees or less when a ZK direction is parallel to the x axis. A line segment ZF is the optical axis of the camera and a line segment ZQ indicates a range in which the camera is capable of being arranged.

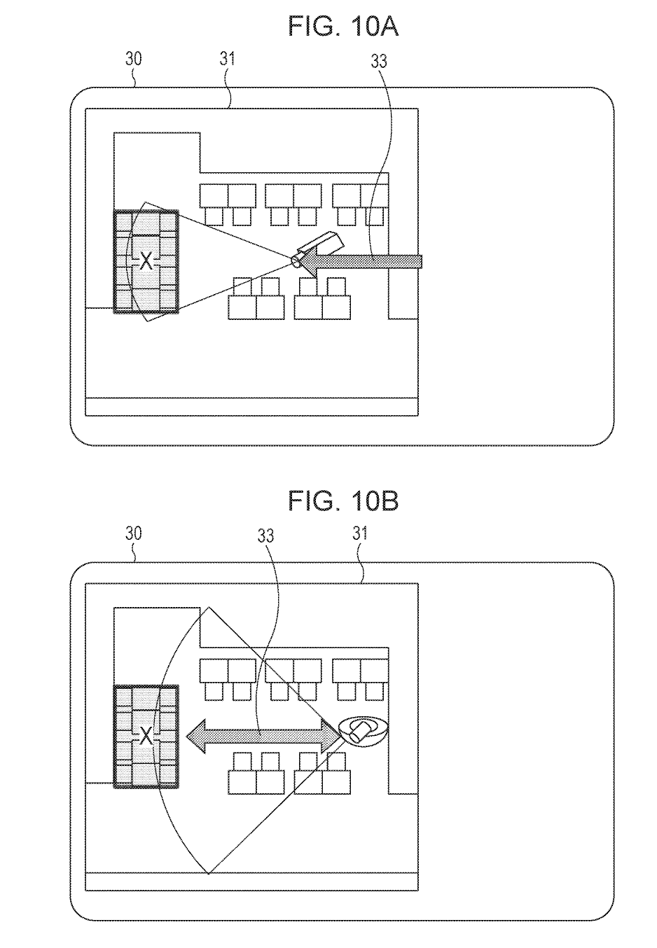

From the above points, a midpoint E of the width AB is defined if the width AB of the detection area 40 is defined. A minimum distance PE from the midpoint E is calculated from the above conditions in a space in which a perpendicular PJ is the x axis. In the case of a camera having a telephoto lens, the minimum distance PE may be longer than that in the second embodiment. Accordingly, when the camera having the above characteristics is selected, the line segment ZQ indicating the position where the camera is desirably arranged is displayed as the mounting position guide 33 in accordance with the characteristics of the camera. FIG. 10A illustrates an example in which the mounting position guide 33 is displayed.

Next, inclusion of a maximum distance QE within a distance at which the human body is capable of being detected is considered as a second condition. A specific example is illustrated in FIG. 9B.

In order for the camera to detect the human body in FIG. 9B, it is necessary for the human body 80 supposed to have a height of, for example, 1.50 m to have a certain size or more (for example, a size of 150 px or more) in an image of a resolution of 640×480 on the detection area 40. Accordingly, a maximum distance Q′E at which an image of the human body is captured at 150 px or more at a specific resolution is capable of being calculated.

For example, in the case of a camera with a wide angle lens having a low resolution, the maximum distance may be smaller than that in the second embodiment. Consequently, when the camera having the above characteristics is selected, the line segment ZQ indicating the position where the camera is desirably arranged is displayed as the mounting position guide 33 in accordance with the characteristics of the camera. FIG. 10B illustrates an example in which the mounting position guide 33 is displayed.

As described above, according to the third embodiment, the camera mounting support apparatus 100 is capable of displaying the mounting position of each camera, which corresponds to the conditions of the camera, in accordance with an input of the kind of the camera in the operation area 34.

### Fourth Embodiment

The mounting position guide 33 is varied depending on the kind of the camera that is to be mounted in the third embodiment. An example will be described in a fourth embodiment in which the mounting condition of the camera of each kind, among multiple cameras that are selected or all the cameras without specifying a camera to be mounted, is displayed and selection of the camera is also supported. Since the internal configuration of the camera mounting support apparatus 100 according to the fourth embodiment is the same as the ones illustrated in FIG. 1 and FIG. 2, a description of the internal configuration of the camera mounting support apparatus 100 according to the fourth embodiment is omitted herein. Only points different from the third embodiment will be described here.

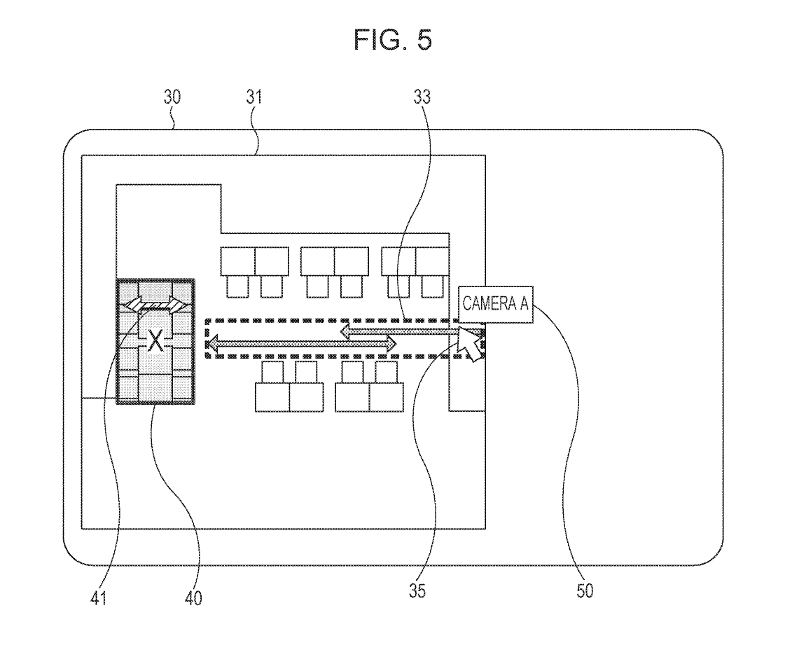

In the fourth embodiment, it is not necessary to individually input the kinds of the cameras in the operation area 34 and multiple cameras or all the cameras are capable of being selected, instead of the input of the kinds of the cameras in the operation area 34. For example, multiple cameras, such as the camera model names of the “Camera A” and the “Camera B”, may be selected or selection may not be performed. When selection is not performed, all the cameras are selected. In the display of the mounting position guides in Step S703, multiple line segments corresponding to multiple camera candidates are displayed. FIG. 5 illustrates an example of how to display the multiple line segments.

Candidates for the multiple mounting positions are displayed on the layout guide 31 in the manner illustrated in FIG. 5 when the detection area 40 and the detection direction 41 are specified. Since the multiple line segments are displayed so as to be overlapped with each other, the line segments may be displayed using different colors or multiple solid-line arrows may be displayed in a dotted-line rectangle representing the line segments, as illustrated in FIG. 5, to display the mounting position guides 33. When the mounting position guides 33 are represented using a rectangle, the line segments are indicated to be originally on a line passing through the center of the rectangle. For example, in response to dragging of the pointer 35 onto the line segment by the user, chip display 50 of the kind of the target camera is displayed. The user knows the candidate for the camera and the mounting position of the camera from the chip display 50.

As described above, according to the fourth embodiment, the camera mounting support apparatus 100 is capable of displaying the multiple mounting positions of the cameras corresponding to the cameras of the respective kinds. Accordingly, the user is capable of selecting a desired camera from the displayed cameras and mounting the selected camera.

### Fifth Embodiment

The multiple mounting position guides corresponding to the multiple kinds of cameras are displayed in the fourth embodiment. An example will be described in a fifth embodiment in which priorities are given to multiple cameras in advance and a desired camera is selected based on the priorities without specifying a camera to be mounted to display the mounting condition of the selected camera. Since the internal configuration of the camera mounting support apparatus 100 according to the fifth embodiment is the same as the ones illustrated in FIG. 1 and FIG. 2, a description of the internal configuration of the camera mounting support apparatus 100 according to the fifth embodiment is omitted herein. Only points different from the fourth embodiment will be described here.

The mounting position guides 33 are displayed in the manner illustrated in FIG. 5 in the fifth embodiment. However, for example, the color, the width, or the display mode of only one line segment may be changed depending on the priorities. Alternatively, only the line segment having the highest priority may be displayed.

The restriction data 280 to be read out in Step S702 also includes information about, for example, the priority of the camera of each kind. The information about the priority is, for example, sort information depending on the price, attribute information indicating whether the camera of the indoor model or the outdoor model is used, distinction of a flagship version and a less-expensive version, or information indicating whether the camera has a function. Here, the priority information may be selected from the operation area 34. In this case, refinement of the priorities or change of the orders may be performed using information about sorting or filtering of the cameras, such as a “price order” or an “outdoor model” that is specified.

As described above, according to the fifth embodiment, the camera mounting support apparatus 100 is capable of displaying a desired camera based on the information about the priority or the like to support mounting of the camera.

### Other Embodiments

The disclosure may be realized by supplying a program realizing one or more functions of the above embodiments to a system or an apparatus via a network or a storage medium and reading out and executing the program by one or more processors in the computer in the system or the apparatus. Alternatively, the disclosure may be realized by a circuit (for example, an application specific integrated circuit (ASIC)) realizing one or more functions.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2016-141290 filed Jul. 19, 2016, which is hereby incorporated by reference herein in its entirety.

What is claimed is:

1. An information processing apparatus comprising:
a display control unit configured to display in a display unit a range in which a camera is capable of being arranged with respect to a position or a range where the camera captures an image based on an imaging condition input with an input unit,
wherein the imaging condition at least includes information about the position or the range where the camera captures an image and about an angle in a vertical direction at which the camera captures an image, and
wherein the input unit is used to input the imaging condition.

2. The information processing apparatus according to claim 1,
wherein the input unit is further used to input information about a kind of the camera, and
wherein the display control unit displays the range in which the camera is capable of being arranged in the display unit based on the information about the kind of the camera.

3. The information processing apparatus according to claim 2,
wherein the kind of the camera is based on at least one of an angle of view, a resolution, an aspect ratio of the camera.

4. The information processing apparatus according to claim 2,
wherein the display control unit displays in the display unit the range in which the camera is capable of being arranged in a range in which an image of a certain size or more of an object is captured by the camera.

5. The information processing apparatus according to claim 2,
wherein the display control unit displays in the display unit the range in which the camera is capable of being arranged in a range including the entire range in which the camera captures an image.

6. The information processing apparatus according to claim 2,
wherein the display control unit displays the range in which the camera of each kind is capable of being arranged in the display unit based on the information about the kind of the camera.

7. The information processing apparatus according to claim 6,
wherein the input unit is further used to input information about priority of the camera of each kind, and
wherein the display control unit displays the range in which the camera of each kind is capable of being arranged in the display unit in a display mode corresponding to the priority of the camera of each kind.

8. The information processing apparatus according to claim 2,
wherein the input unit is further used to input information about priority of the camera of each kind, and
wherein the display control unit displays a range in which the camera having a highest priority is capable of being arranged in the display unit.

9. An information processing method comprising:
displaying in a display unit a range in which a camera is capable of being arranged with respect to a position or a range where the camera captures an image based on an imaging condition input with an input unit,
wherein the imaging condition at least includes information about the position or the range where the camera captures an image and about an angle in a vertical direction at which the camera captures an image, and
wherein the input unit is used to input the imaging condition.

10. A non-transitory computer-readable storage medium storing a computer-executable program causing a computer to execute a method comprising:
displaying in a display unit a range in which a camera is capable of being arranged with respect to a position or a range where the camera captures an image based on an imaging condition input with an input unit,
wherein the imaging condition at least includes information about the position or the range where the camera captures an image and about an angle in a vertical direction at which the camera captures an image, and
wherein the input unit is used to input the imaging condition.
